(19) United States
(12) Patent Application Publication
(10) Pub. No.: US 2008/0155637 A1
(43) Pub. Date: Jun. 26, 2008

(54) Method and System for Acquiring Information on the Basis of Media Content

(75) Inventor: Thomas L. Du Breuil, Ivyland, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/613,292

(22) Filed: Dec. 20, 2006

(51) Int. Cl. H04N 7/173

(52) U.S. Cl. 725/134; 725/105

(57) ABSTRACT

A method and a system for acquiring information on the basis of a media content (106) is disclosed. The method includes detecting (304) one or more particular image patterns or audio patterns in the media content to correspond to one or more of a plurality of pre-defined image and audio patterns. Further, the method further includes associating (306) a detected image pattern or the audio pattern to a predetermined list of response profiles. Furthermore, the method includes executing (308) one or more associated response profiles.

### FIELD OF THE INVENTION

The present invention generally relates to managing a media content, and more particularly, to a method and system for acquiring information on the basis of the media content.

### BACKGROUND OF THE INVENTION

A set-top box (STB) is a device that is capable of receiving a signal from various sources such as an Ethernet cable, a satellite dish, a coaxial cable, and/or an antenna, etc. The STB then converts the signal into content that can be displayed on the screen of a display device. The STB can also be referred to as a receiver that receives information or content, which could be video, audio and/or audiovisual content in the signal. Further, the receiver can be connected to or integrated into an electronic device, such as, a television (TV) set and/or an audio system. The receiver is further capable of accepting commands from a user and transmitting these commands to a network operator through a back channel or other return path such as an IP connection. The commands can be given to the receiver through a hand-held remote control device, a keypad, a voice-recognition unit or a keyboard. A Digital Video Recorder (DVR) capable of recording the information or content displayed on the screen can also be embedded in the STB. The DVR records video programming from the TV set. These DVRs are operated by personal video recording software, which enable the viewer to perform various operations on the video, to manage the video or audio content. Examples of such operations can be pause, forward, play and/or rewind.

There are many methods for selecting programs to record and find more information on the content being received by the STB. One such method comprises enabling text-based searches through an Electronic Program Guide (EPG) database by program title, type, actor, etc. This method requires text entry to provide an input search string to the STB, to record the content. However, entering text in the TV environment is difficult and requires the user to know about the desired programming in advance in order to perform a useful search.

In accordance with another method for recording the content, special Vertical Blanking Interval (VBI) tags are used. VBI traditionally refers to analog television signals, but the corresponding concept exists within digital television signals in the form of embedded data within the stream. The VBI tags are inserted in a video stream during promotional advertising for upcoming TV shows. By using the VBI tags, the user is apprised of the event and given the option of recording the advertised show. This feature can be implemented in either recording live TV shows or during the playback of a pre-recorded show, before the advertised event. Further, advertisers can buy a promotion on the DVR through VBI signaling. However, this requires insertion of special VBI tags by programmers, which are transmitted through an end-to-end system to the user's STB. Therefore, such a service requires a service provider to have a contractual relationship with a manufacturer of the STB. It can require a contractual relationship with video distributors as well since they can chose to strip, or eliminate, this VBI data from the program prior to transmitting it to the consumer.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates a block diagram of a system for acquiring information of the media content, in accordance with various embodiments of the present invention;

FIG. 2 depicts a flow diagram illustrating a method for acquiring information on the basis of a media content, in accordance with various embodiments of the present invention; and

FIGS. 3 and 4 illustrate another flow diagram for acquiring information on the basis of a media content, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve an understanding of embodiments of the present invention.

### DETAILED DESCRIPTION

Before describing in detail the particular method and system for acquiring information of a media content, in accordance with various embodiments of the present invention, it should be observed that the present invention resides primarily in combinations of method steps related to acquiring information of a media content, on the execution of the media content in an electronic device. Accordingly, the apparatus components and method steps have been represented, where appropriate, by conventional symbols in the drawings, showing only those specific details that are pertinent for an understanding of the present invention, so as not to obscure the disclosure with details that will be readily apparent to those of ordinary skill in the art, having the benefit of the description herein.

In this document, the terms ‘comprises,’ ‘comprising,’ or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by ‘comprises . . . a’ does not, without more constraints, preclude the existence of additional identical elements in the process, method, article or apparatus that comprises the element. The term ‘another,’ as used in this document, is defined as at least a second or more. The terms ‘includes’ and/or ‘having’, as used herein, are defined as comprising.

In accordance with various embodiments of the present invention, a method for acquiring information on the basis of a media content is provided. The method includes detecting at least one particular image and/or an audio pattern within the media content to correspond to at least one of a plurality of pre-defined image patterns and audio patterns. Further, the method includes associating the detected image and/or audio pattern with at least one of a predetermined list of response profiles. Furthermore, the method includes executing the at least one of an associated response profile to acquire information.

In accordance with various embodiments of the present invention, a system for acquiring information on the basis of a media content is provided. The system includes a memory means for storing a plurality of image and audio patterns. Further, the system includes a processor adapted for analyzing the audio and/or visual media content and detecting an occurrence of at least one of the plurality of stored image and/or audio patterns. Furthermore, the system includes a database for associating the detected image and/or audio pattern with at least one of the plurality of stored response profiles.

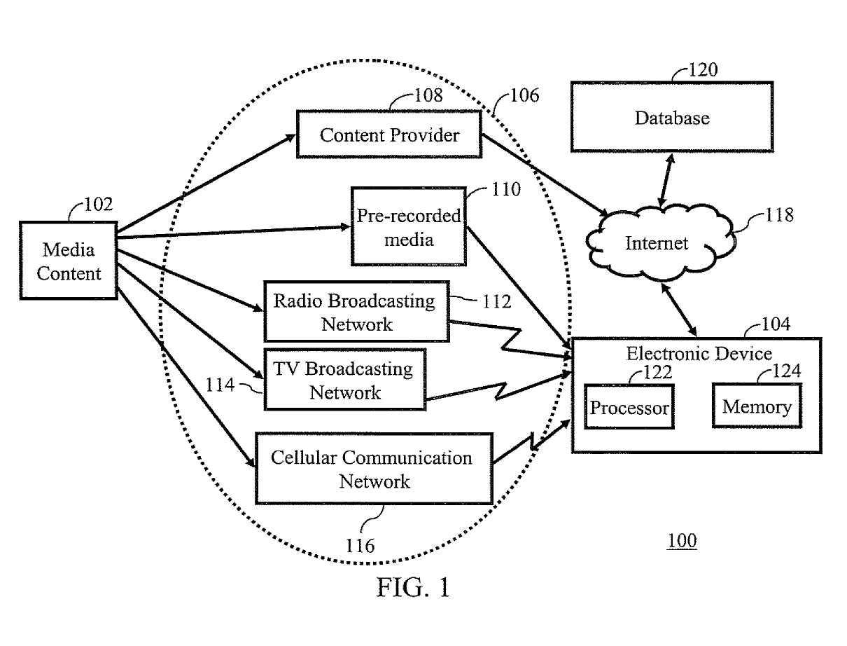

FIG. 1 illustrates a block diagram of a system 100, for acquiring information of media content 102, in accordance with various embodiments of the present invention. An electronic device 104 can receive a signal from various wired and wireless communication sources. The wired and wireless communication sources can be an Ethernet cable, a satellite dish, a Television (TV) broadcaster, a cellular network, an optical fiber, a coaxial cable, a telephone line, a Digital Subscriber Line (DSL) connection, an ordinary Very High Frequency (VHF) antenna, an Ultra High Frequency (UHF) antenna and the like. The electronic device 104 then converts the signal into content that can be displayed on a screen of a display device. The content received in the signal could be a still image, a video signal, an audio signal, or an audiovisual signal. The electronic device 104 can be connected to or integrated with another electronic device such as a television (TV) set, an audio system, a mobile phone, a laptop, a personal computer (PC) and the like. The electronic device 104 is further capable of accepting commands from a user and may optionally transmit some of these commands to a network operator by using a back channel. These commands can be input to the electronic device 104 through a handheld remote control, a keypad, a voice recognition unit or a keyboard. In accordance with various embodiments of the present invention, the electronic device 104 can be a set-top box (STB), a Digital Video Recorder (DVR), a Digital TV, an integrated audio system, and similar devices.

The electronic device 104 is capable of receiving the media content 102 from a plurality of delivery mechanisms 106. Examples of the plurality of media delivery mechanisms 106 include, but are not limited to, a content provider 108, a pre-recorded media 110 (which can be a DVD, a CD, a cassette, videotapes, recordings and the like), a radio broadcasting network 112, a TV broadcasting network 114, a cellular communication network 116, a satellite, a cable, Digital Video Broadcasting-Handheld (DVB-H), Digital Multimedia Broadcasting (DMB), a MovieBeam™, Direct TV™, pre-recorded media such as DVDs, CDs, video tapes. The content provider 108 can be a company, a media center or any other agency that delivers the media content 102 to users via the Internet 118. The media content 102 can then be streamed or downloaded from the Internet 118. Examples of the content provider 108 include, but are not limited to, Akimbo™, MovieLink™, youtube™, Comcast and other peer to peer networks.

It should be appreciated that the plurality of media delivery mechanisms 106 can include one or more of the above-mentioned media content sources. Further, the plurality of media content sources can include some other media content providers that have not been mentioned above.

The electronic device 104 can access the database 120 to acquire the information related to the media content 102. The database 120 can be accessed via the Internet 118 or the database 120 can use recorded media such as a CD or DVD to provide the information to the electronic device 104. The electronic device 104 includes a processor 122 and a memory 124. The electronic device 104 receives the media content 102 from the plurality of media delivery mechanisms 106. The memory 124 is capable of storing a number of predefined image patterns and audio patterns. The memory 124 can be a flash memory, a Random Access Memory (RAM), flash RAM, an optical disk, a magnetic storage device, a floppy disk drive, a hard disk drive or any other storage device. The predefined image patterns can include a plurality of alphanumeric characters, likeness of a particular individual, (for example, Brad Pitt, George Bush, Rafael Nadal, etc), likeness of a particular object, (for example, sunglasses, a car, a football, a corporate logo, etc.), and likeness of a particular geographic location, (for example, the Andes, India, the Sahara Desert, etc.). The predefined audio patterns can include a particular musical composition (a combination of musical notes), a plurality of particular words (a part of the lyrics of a song, a dialogue, etc.), a plurality of vocal patterns (to identify people by their speech or vocal sounds) etc. The processor 122 is adapted to analyze an audio and visual composition of the media content 102. Further, the processor 122 detects an occurrence of at least one of the predefined plurality of image patterns and audio patterns, stored in the memory 124, in the media content 102. When the processor 122 detects a match between a particular image pattern or audio pattern in the media content 102 and the database 120, the processor 122 associates the detected image and/or the audio pattern with at least one of a plurality of response profiles. The plurality of response profiles can include a list of control files relating to various programs. These programs can either auto program a particular media appliance or provide a user with the opportunity of browsing through a number of options, and make his/her choice, based on his/her preference. The plurality of response files can include recording a particular media content, for example, a movie, a song or an advertisement, a media program list that can include other programs (based on the preference of a particular individual), a commercial advertisement, a link to an Internet site, a still image, an audio track, a text message, etc.

For another embodiment of the present invention, three different processors can be provided to perform various operations of the processor 122. The electronic device 104 can include a first processor that is adapted to program an operation of one or more media appliances in response to an execution of at least one of the response profiles. For example, let us consider that the electronic device 104 is input instructions to record a movie named XYZ. After the processor 122 analyzes the media content 102, the first processor automatically records and stores the media content 102 in the memory 124 if the analyzed media content matches at least one of the plurality of predefined image and/or audio patterns. Further, the electronic device 104 can include a second processor that is adapted to transmit a communication to the user of the media content 102, in response to the execution of the response profile. The communication can provide the user with access to the control files listed in the plurality of response profiles. The communication can include a media program listing, a downloadable commercial advertisement, a link to a website on the Internet, an audio file, a text message, etc.

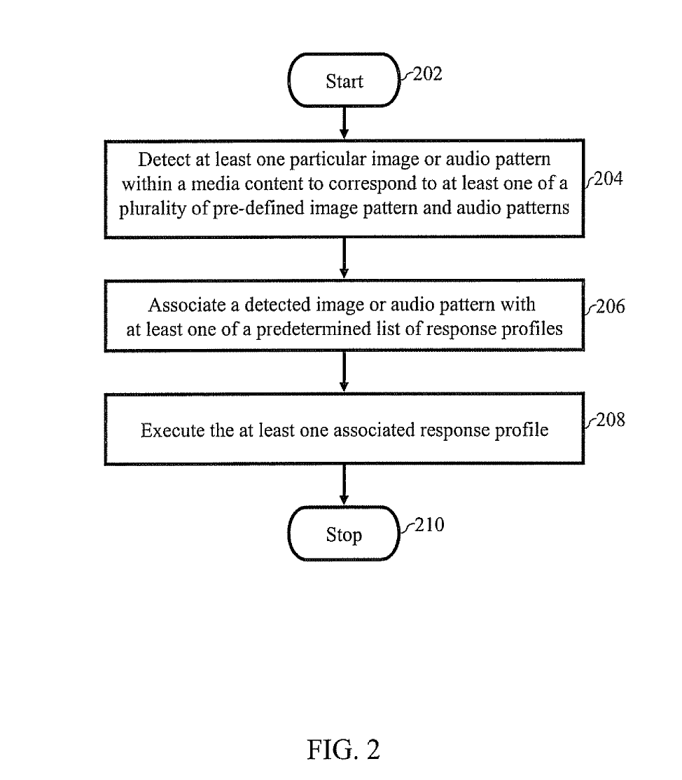

FIG. 2 is a flow diagram illustrating a method for acquiring information on the basis of the media content 102, in accordance with various embodiments of the present invention. The acquired information can then either be used to select programs, to be recorded on a Digital Video Recorder (DVR), or can be used for Interactive Television (iTV) applications such as online shopping, providing web links, etc., without the requirement of making any text entry.

The method is initiated at step 202. At step 204, the electronic device 104 analyzes the media content 102 being executed at the electronic device 104. The media content 102 is received from at least one media delivery mechanism 106. The media delivery mechanism 106 can be wired or wireless. Few examples of the media delivery mechanism 106 can include, but are not limited to, a cable distribution system, a satellite distribution system, an optical distribution system, the content provider 108, the pre-recorded media 110, the radio broadcasting network 112, the TV broad casting network 114, the cellular communication network 116, the Internet 118, a Digital Subscriber Loop (DSL), Asymmetric Digital Subscriber Loop (ADSL), and ADSL2. The analysis of the media content 102 includes performing one or more of an Optical Character Recognition (OCR) algorithm, audio analysis and visual recognition analysis to extract a metadata of the media content 102. After the media content 102 has been analyzed, the processor 122 compares a portion of the metadata of the media content 102 and at least one of the pre-defined image and/or audio patterns stored in the memory 124. The pre-defined image patterns can include a plurality of alphanumeric characters, likeness of a particular individual, (for example, Angelina Jolie), likeness of a particular object, (for example, a pen), likeness of a particular geographic location, (for example, the Himalayas). The pre-defined audio patterns can include a plurality of particular words, a particular musical composition, a plurality of vocal patterns etc. If a match between the pre-defined image and/or audio pattern and a part of the metadata is found, the electronic device 104 associates a detected image and/or audio pattern with a list of response profiles stored in the database 120 at step 206. The list of response profiles includes automatic programming of one or more media appliances, a media program listing, a link to an Internet site, a still image, an audio track or a text image. The automatic programming can include recording the media content 102, generating an alert on finding the match. At step 208, at least one of the list of response files is executed, depending on a user requirement to acquire information about the media content 102. After executing at least one of the response profiles, the method halts at step 210 or returns to the step 202 and looks for another match.

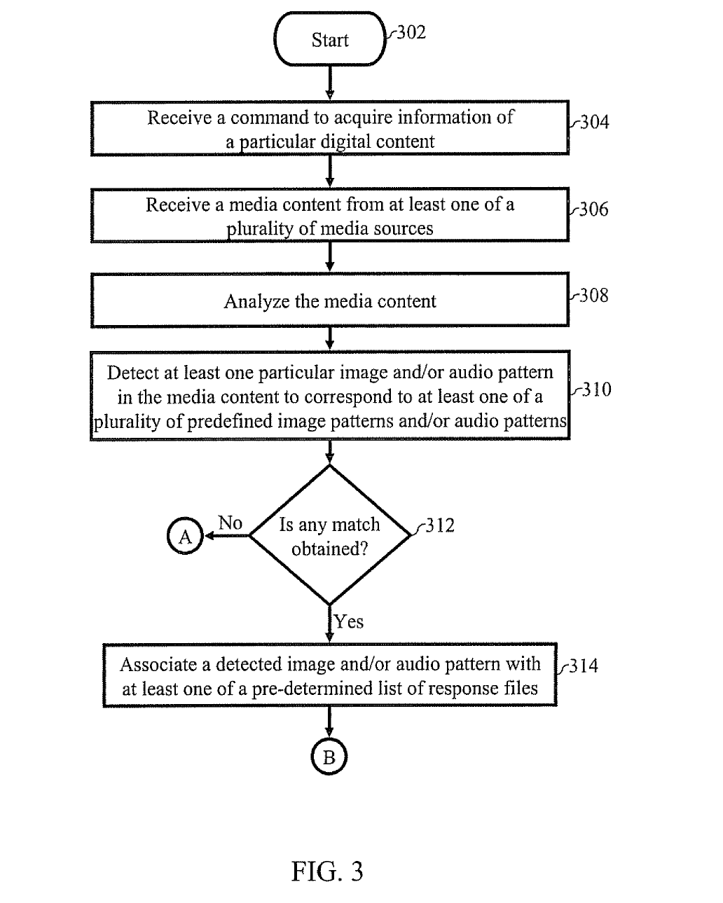

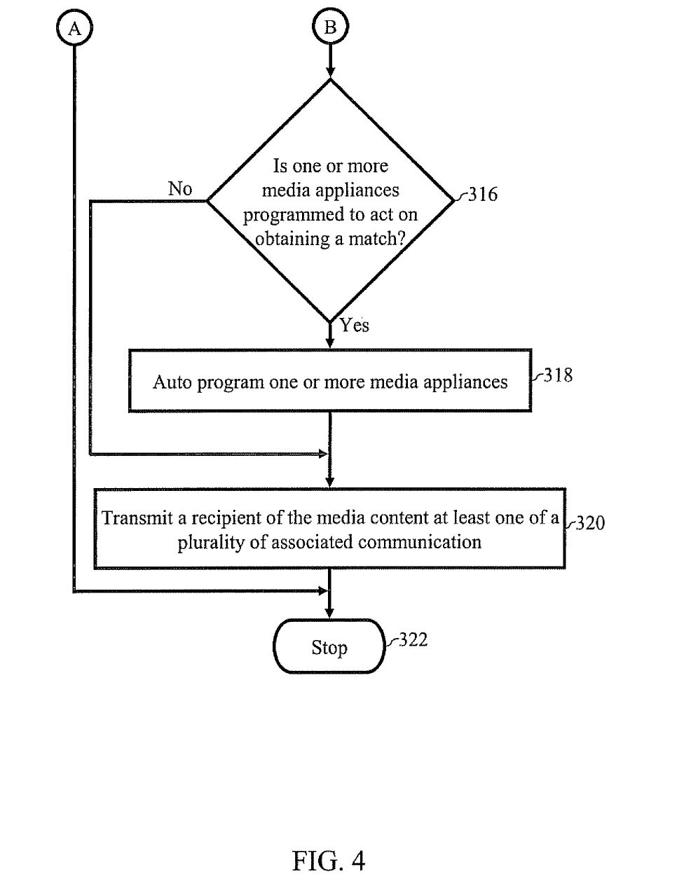

FIGS. 3 and 4 illustrate another flow diagram for acquiring information on the basis of the media content 102, in accordance with an embodiment of the present invention. The method initiates at step 302. At step 304, the electronic device 104 receives a command to acquire information about the media content 102. For example, the electronic device 104 can receive instructions to acquire information about a movie XYZ. The command or instruction can be input to the electronic device 104 through various means, such as, through a handheld remote control, a keypad, a voice recognition unit or a keyboard. At step 306, the electronic device 104 receives the media content 102 from at least one of a plurality of media sources 106. For example, the media content 102 could be received at the electronic device 104 from a number of media sources wirelessly or in a wired manner. Examples of such media sources are the content provider 108, the pre-recorded media 110, the radio broadcasting network 112, the TV broadcasting network 114, and the cellular communication network 116, a cable distribution system, a satellite distribution system and an optical distribution system, a DSL, a ADSL, and an ADSL2.

At step 308, the processor 122 analyzes the media content 102. For one embodiment, the analysis includes executing the Optical Character Recognition (OCR) algorithm, the audio analysis and the visual recognition analysis, to extract the metadata of the media content 102. The OCR algorithm includes scanning the media content 102 to convert the metadata into alpha numeric characters. The alpha numeric characters can include information, such as, a program name, a program type, a program genre, etc. The audio analysis of the media content 102 refers to extraction of information and meaning from audio signals. The information and meaning can be used for analysis, classification, storage, retrieval, synthesis, etc. The metadata can include information about a particular data set, which can describe, for example, how, when and by whom it was received, created, accessed and/or modified, and how it is formatted. At step 310, the processor 122 compares the one or more image and/or audio patterns in the metadata and at least one of a plurality of pre-defined image and/or audio patterns. The pre-defined image and audio patterns can be stored in the memory 124 of the electronic device 104. The image patterns can include a plurality of alphanumeric characters (containing information on the media content 102, such as, a video name, a video type, the date the video was released etc.), likeness of a particular individual (for example Collin Firth, Roger Federer, Tony Blair, etc.), likeness of a particular object (e.g. a building, a statue, a bus, etc.), and a particular geographic location, (e.g., the Ganges, Niagara Falls, Antarctica, etc.). The audio patterns can include a plurality of particular words (a part of the lyrics of a song or a dialogue) and a particular musical composition (e.g. a particular combination of musical notes). If a match is obtained between the one or more image and/or audio patterns in the metadata and at least one of the pre-defined image and/or audio patterns at step 312, the electronic device 104 associates a detected image and/or audio pattern in the media content 102 with a list of response profiles at step 314. The list of response profiles is provided by the electronic device 104 through the database 120, which contains additional information about the media content 102. For example, let us consider that the electronic device 104 has been input instructions to acquire information pertaining to the movie XYZ, and the instruction input is the names of an actor and actress in the movie. This information relating to the actor and actress in the movie XYZ is stored as pre-defined image patterns. If the media content 102 contains the movie XYZ, the processor 122 finds the match for the pre-defined image pattern in the media content 102 after analyzing the media content 102. On finding the match, the electronic device 104 associates a detected image pattern with a list of response profiles. If a match is not obtained between the one or more image and/or audio patterns in the metadata and at least one of the pre-defined image and/or audio patterns at step 312, the method terminates at step 322, or returns to the step 302 and looks for another match.

At step 316, in FIG. 4, the electronic device 104 checks whether any media appliance is programmed to act after the match has been obtained. For example, one or more media appliances can be programmed to record a particular media content, based on the analysis of the media content 102 by the processor 122. Based on the step 316, if one or more media appliances are programmed to act, at step 318, the media appliance can record the media content 102, generate an audio alert at another electronic device, generate a Short Message Service (SMS) alert, generate an electronic mail alert, switch on a Television set to a powered on mode from a standby mode of operation, etc. For example, for an embodiment of the present invention, if the DVR is instructed to record the movie XYZ on finding the match at 310, the DVR automatically records the movie XYZ. At step 320, one or more communications from the list of response profiles is transmitted to the user of the electronic device 104. Further, if at step 316, no media appliance is programmed to act on finding the match, at step 320, one or more communications from the list of response profiles is transmitted to the user of the electronic device 104. The one or more communications can be a media program listing, a commercial advertisement, a link to an Internet site, a still image, an audio track, a text image and the like. The one or more communications can provide the user with access to at least one of the list of response profiles. For example, the electronic device 104 can provide the user with the list of response profiles that contain an advertisement to buy a DVD of the movie, a link to the site of the actor and/or actress in the movie, a link to download stills of the movie, etc. The user then selects one or more response profiles from the list to acquire information. The method then halts at step 324, or returns to the step 302 to look for another match.

Various embodiments of the present invention provide a method and a system for acquiring information on the basis of a media content. The invention offers various advantages. The invention does not require manufacturers of an electronic device to have a contractual relationship with program creators, owners, distributors, service providers or advertisers, for a feature to function. However, program creators and advertisers can take advantage of the present invention by making sure that their programs and advertisements are conducive to the Optical Character Recognition (OCR) and/or visual/audio scan engines. In addition to the text strings, the electronic device can identify people, products, corporate logos, voices, songs, etc. from all the advertisements and programs. The techniques described here can be combined with the conventional approach of scanning text in closed captioning data, if present, or scanning for VBI tags, if defined, to improve overall system performance and robustness. Further, the present invention allows easy selection of programs that need to be recorded in the DVR.

It will be appreciated that the method and system for acquiring information on the basis of a media content described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to enable users to acquire information of a media content. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one of ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for acquiring information on the basis of content comprising at least one of audio, still image, and visual media content, the method comprising:
detecting at least one particular image or audio pattern within the content, the detected image or audio pattern corresponding to at least one of a plurality of predefined image and audio patterns;
associating the detected image or audio pattern with at least one of a predetermined list of response profiles; and
executing the at least one associated response profile.

2. The method of claim 1 wherein the content is received via a broadcast television signal.

3. The method of claim 1 wherein the content is received via a cable distribution signal.

4. The method of claim 1 wherein content is received via a satellite distribution signal.

5. The method of claim 1 wherein the content is received via an optical distribution signal.

6. The method of claim 1 wherein the content is received via a wireless distribution network.

7. The method of claim 1 wherein the content is received via a wired distribution network.

8. The method of claim 1 wherein the content is received via a Digital Subscriber Loop (DSL) type distribution scheme.

9. The method of claim 1 wherein the content is received via the internet.

10. The method of claim 1 wherein the content is received via a cellular communication network.

11. The method of claim 1 wherein the content is acquired from pre-recorded media.

12. The method of claim 1 wherein at least one of the plurality of predefined image patterns comprises a plurality of alphanumeric characters.

13. The method of claim 1 wherein at least one of the plurality of predefined image patterns comprises the likeness of a particular individual.

14. The method of claim 1 wherein at least one of the plurality of predefined image patterns comprises the likeness of a particular object.

15. The method of claim 1 wherein at least one of the plurality of predefined image patterns comprises the likeness of a particular geographic location.

16. The method of claim 1 wherein at least one of the plurality of predefined audio patterns comprises a plurality of particular words.

17. The method of claim 1 wherein at least one of the plurality of predefined audio patterns comprise a plurality of vocal patterns.

18. The method of claim 1 wherein at least one of the plurality of predefined audio patterns comprises a particular musical composition.

19. The method of claim 1 wherein the execution of the at least one response profile performs the automatic programming of one or more media appliances.

20. The method of claim 1 wherein the execution of the at least one response profile transmits to the recipient of the content an associated communication.

21. The method of claim 20 wherein the associated communication comprises at least one of: a media program listing, a commercial advertisement, a link to an internet site, a still image, an audio track, a text message.

22. A system for acquiring information on the basis of audio and/or still image and/or visual media content comprising:
a memory means storing a plurality of image and audio patterns;
a processor adapted to analyze the audio and/or visual media content and detect the occurrence of at least one of the plurality of stored image and/or audio patterns; and
a database associating the detected image and/or audio pattern with at least one of the plurality of stored response profiles.

23. The system of claim 22 wherein the audio and/or visual media content is received from a broadcast television signal.

24. The system of claim 22 wherein the audio and/or visual media content is received from a cable distribution signal.

25. The system of claim 22 wherein the audio and/or visual media content is received from a satellite distribution signal.

26. The system of claim 22 wherein the audio and/or visual media content is received from an optical distribution signal.

27. The system of claim 22 wherein the audio and/or visual media content is received from a wireless distribution network.

28. The system of claim 22 wherein the audio and/or visual media content is received from a wired distribution network.

29. The system of claim 22 wherein the audio and/or visual media content is received from a Digital Subscriber Loop (DSL) signal.

30. The system of claim 22 wherein the audio and/or visual media content is received from an internet-based communication.

31. The system of claim 22 wherein the audio and/or visual media content is received from a cellular network communication.

32. The system of claim 22 wherein the audio and/or visual media content is retrieved from pre-recorded media.

33. The system of claim 22 wherein at least one of the plurality of stored image patterns comprises a plurality of alphanumeric characters.

34. The system of claim 22 wherein at least one of the plurality of stored image patterns comprises the likeness of a particular individual.

35. The system of claim 22 wherein at least one of the plurality of stored image patterns comprises the likeness of a particular object.

36. The system of claim 22 wherein at least one of the plurality of stored image patterns comprises the likeness of a particular geographic location.

37. The system of claim 22 wherein at least one of the plurality of stored audio patterns comprises a plurality of particular words.

38. The method of claim 22 wherein at least one of the plurality of stored audio patterns comprise a plurality of vocal patterns.

39. The method of claim 22 wherein at least one of the plurality of stored audio patterns comprises a particular musical composition.

40. The system of claim 22 further comprising:
a processor adapted to program the operation of one or more media appliances in response to the execution of the at least one response profile associated with the detected image and/or audio pattern.

41. The system of claim 22 further comprising:
a processor adapted to transmit an associated communication to the recipient of the audio and/or visual media content in response to the execution of the at least one response profile associated with the detected image and/or audio pattern.

42. The system of claim 41 wherein the associated communication comprises at least one of: a media program listing, a commercial advertisement, a link to an internet site, a still image, an audio track, a text message.
